(19) United States
(12) Patent Application Publication
(10) Pub. No.: US 2026/0264283 A1
(43) Pub. Date: Sep. 10, 2026

(54) MANDOLINE

(71) Applicants: Dzmitry VARHAN, New York, NY (US); KAZ EUROPE SÀRL, Bussigny (CH)

(72) Inventors: Dzmitry Varhan, Dingmans Ferry, PA (US); Carly Cheng, New York, NY (US)

(21) Appl. No.: 19/168,070

(22) PCT Filed: Apr. 3, 2024
(86) PCT No.: PCT/US2024/022766

§ 371 Date: Sep. 23, 2025

Related U.S. Application Data
(60) Provisional application No. 63/458,489, filed on Apr. 11, 2023.

(51) Int. Cl. B26D 3/28; B26D 7/06; B26D 7/26

(52) U.S. Cl. CPC B26D 3/283; B26D 7/06; B26D 7/2628

(57) ABSTRACT

A mandoline including a housing, a sled, a blade, a chute, and a sled lock. The sled is connected with the housing and slidable with respect to the housing. The blade is connectable with the sled, and when connected the sled and the blade move together with respect to the housing. The chute is connectable with the housing. The sled lock is connected with the housing and operable between a locked position in which the sled is inhibited from sliding with respect to the housing, and an unlocked position in which the sled is movable with respect to the housing, where the chute contacts the sled lock to move the sled lock toward the unlocked position when the chute is connected with the housing.

### BACKGROUND

A mandoline is a culinary utensil used to perform slicing, cutting juliennes, making crinkle-cuts, and similar food processing with two parallel working surfaces including a first planar surface and a main blade, one of which can be adjusted in height. Known mandolines include a main blade that becomes dirty and worn after use, but is difficult to access for cleaning, refurbishment, or replacement. Further, the main blade in known mandolines is often uncovered, uncontrolled, or otherwise difficult to reliably wield. Consequently, there is a demand for a mandoline which offers greater control and coverage of, and convenient access to, the main blade used for food processing.

### SUMMARY

According to one aspect, a mandoline includes a housing, a sled, a blade, a chute, and a sled lock. The sled is connected with the housing and slidable with respect to the housing. The blade is connectable with the sled, and when connected the sled and the blade move together with respect to the housing. The chute is connectable with the housing. The sled lock is connected with the housing and operable between a locked position in which the sled is inhibited from sliding with respect to the housing, and an unlocked position in which the sled is movable with respect to the housing, where the chute contacts the sled lock to move the sled lock toward the unlocked position when the chute is connected with the housing.

According to another aspect, a mandoline includes a housing, a sled, a cartridge, and a blade adjustment mechanism. The sled is connected with the housing and slidable with respect to the housing. The cartridge includes a blade and a platform connectable with the sled, and when connected the sled and the cartridge move together with respect to the housing. The blade adjustment mechanism is operably connected with at least one of the blade and the platform to adjust an offset between a cutting edge of the blade with respect to a leading edge of the platform where the blade adjustment mechanism is actuated between a first operating position and a second operating position, and the blade adjustment mechanism obstructs removal of the cartridge from the housing when the blade adjustment mechanism is in the first operating position.

According to another aspect, a mandoline includes a housing, a platform, a blade, a chute, a ridge, and a catch mechanism. The platform is connectable with the housing. The blade is connectable with the housing, and when connected the platform and the blade move together with respect to the housing. The chute is connectable with the housing and configured to store a food item against the platform. The ridge is disposed along an outer surface of the chute. The catch mechanism is connected with the housing, and includes a protrusion, a catch, and a button. The protrusion is configured to engage the ridge, locking the chute connected with the housing. The catch spring biases the protrusion toward engagement with the ridge. The button is operable to disengage the protrusion from the ridge, where pressing the button normal to the platform drives the protrusion from the ridge, unlocking the chute from the housing.

According to another aspect, a mandoline includes a housing, a sled connected with the housing and slidable with respect to the housing, and a blade connected with the sled such that the sled and the blade move together with respect to the housing. The mandoline also includes a chute connectable with the housing, and a container that catches slices of food items which fall from the chute and the housing by gravity, where the container is shaped to nest with the housing and the sled in a stored state.

### BRIEF DESCRIPTION OF THE DRAWINGS

FIG. 1 is an exploded front perspective view of a mandoline with a food pusher removed from a chute.

FIG. 2 is a back perspective view of the mandoline.

FIG. 3 is a front perspective view of the mandoline with the chute removed from a housing.

FIG. 4 is a partially exploded front perspective view of the mandoline with a main housing cover and the chute removed.

FIG. 5 is an enlarged front perspective view of the mandoline with a catch mechanism.

FIG. 6 is a cross-sectional view of the mandoline with the catch mechanism depicted in FIG. 5.

FIG. 7 is a perspective view of the housing, the sled, and the cartridge, with a cover disposed in an open position with respect to the housing.

FIG. 8 is an enlarged view of a right sled lock depicted in FIG. 7.

FIG. 9 is an exploded front perspective view of a housing, a sled, a cartridge, a left sled lock, and the right sled lock included in the mandoline.

FIG. 10 is an exploded left perspective view of the housing, the sled, and the cartridge.

FIG. 11 is a perspective view of the cartridge.

FIG. 12 is an exploded view of the cartridge.

FIG. 13 is a further exploded view of the cartridge.

FIG. 14 is a schematic view of an alternative sled and cartridge for the mandoline.

FIG. 15 is a schematic cross-sectional side view of another alternative sled and cartridge for the mandoline.

FIG. 16 is a schematic rear view of the alternative sled and cartridge depicted in FIG. 15.

FIG. 17 is an exploded schematic perspective view of another sled and cartridge for the mandoline.

FIG. 18 is a schematic cross-sectional side view of the sled and cartridge depicted in FIG. 17.

FIG. 19 is a schematic view of an alternative chute and sled lock for the mandoline.

FIG. 20 is a schematic cross-sectional view of the chute and sled lock of FIG. 19.

FIG. 21 is a right side view of the mandoline disposed in a stored state.

FIG. 22 is an enlarged partial perspective view of the mandoline of FIG. 21.

FIG. 23 is a right side view of the mandoline of FIG. 21, disposed in an in-use state.

FIG. 24 is a right side perspective view of the mandoline of FIG. 21, disposed in the in-use state.

FIG. 25 is an exploded right side perspective view of the mandoline of FIG. 21.

FIG. 26 is an exploded left side perspective view of the mandoline of FIG. 21.

### DETAILED DESCRIPTION

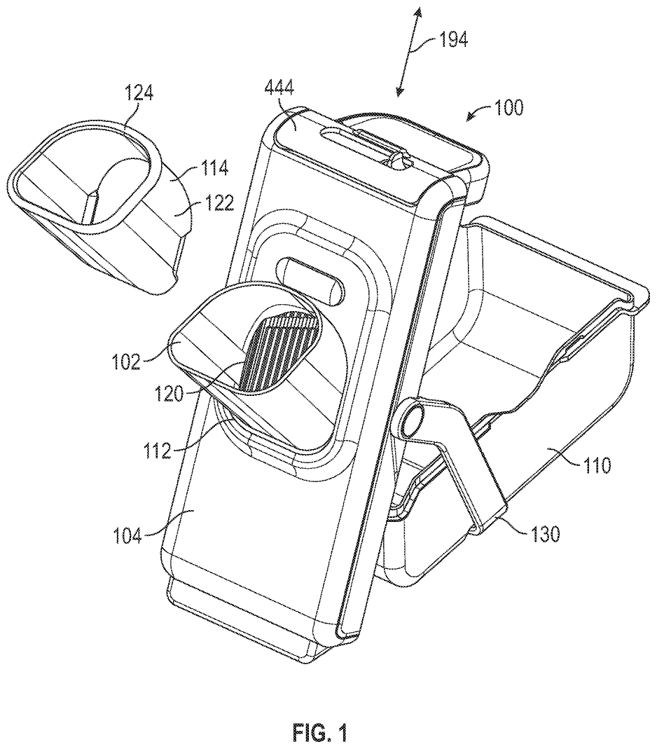

Referring now to the drawings, where like numerals refer to like parts throughout the several views, FIG. 1 depicts a mandoline 100 including a chute 102 connected with a housing 104 and a container 110. The chute 102 is inserted into an aperture 112 defined by the housing 104, and configured to store a food item to be sliced by the mandoline 100 in a manner to be described in more detail below. The mandoline 100 also includes a food pusher 114 configured for insertion into the chute 102 to press a food item stored in the chute 102 toward and against a platform 120 connected with the housing 104.

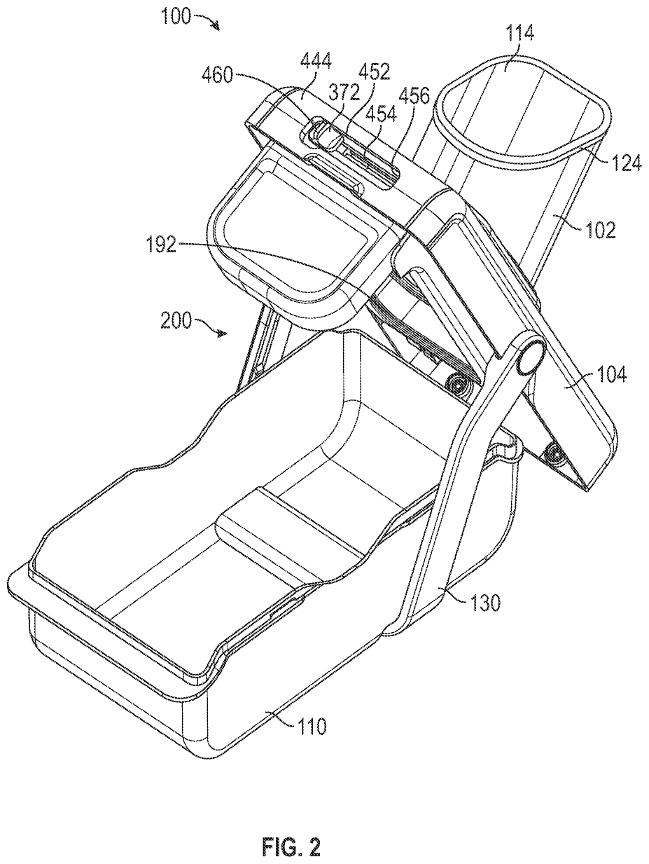

The food pusher 114 includes a stem 122 shaped for insertion into the chute 102, and a grip 124 configured for being actuated by a user and driving the stem 122 into the chute 102. The stem 122 is complementary with the chute 102 to occupy a cross-sectional area of the chute 102, and the chute 102 has an irregular shape such that the food pusher 114 is incapable of rotating with the stem 122 inserted in the chute 102, as depicted in FIG. 2. With continued reference to FIG. 2, the grip 124 is wider than the stem 122, and obstructs the stem 122 from further insertion into the chute 102 when the stem 122 is fully inserted into the chute 102.

The container 110 is positioned below the chute 102 and the housing 104 to catch slices of food items which fall from the chute 102 and the housing 104 by gravity. A leg 130 extended around the container 110 fixes the housing 104 with the container 110, and supports the container 110 over the housing 104.

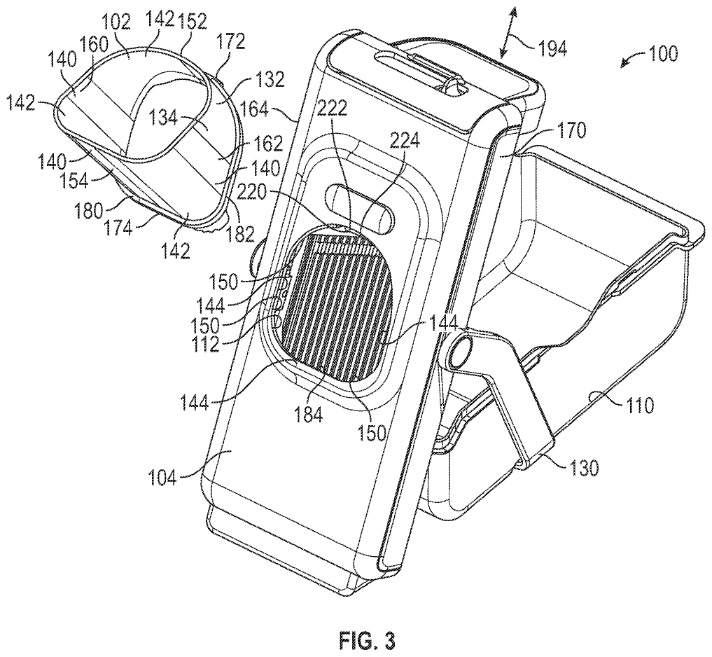

FIG. 3 depicts the chute 102 spaced from the aperture 112. The chute 102 is formed from a wall 132 having an outer surface 134 complementary to the aperture 112 for insertion into the aperture 112 such that the chute 102 is incapable of rotating relative to the housing 104 when inserted in the aperture 112. In this regard, the wall 132 includes alternating flat chute segments 140 and curved chute segments 142 which produce an irregular shape in the outer surface 134 configured to snug fit corresponding flat aperture edges 144 and curved aperture edges 150 of the housing 104 defining the aperture 112.

The flat chute segments 140 and curved chute segments 142 form a top chute side 152, a bottom chute side 154, a left chute side 160, and a right chute side 162 of the chute 102. The top chute side 152 is positioned as an upper portion of the chute 102 when the chute 102 is inserted in the aperture 112 as shown in FIG. 2. With continued reference to FIG. 3, the bottom chute side 154 is positioned opposite the top chute side 152, as a lower portion of the chute 102 when the chute 102 is inserted in the aperture 112. The top chute side 152 is planar, and in this manner configured for supporting food items having a variety of shapes in the chute 102.

The left chute side 160 and the right chute side 162 are interposed between and separate the top chute side 152 and the bottom chute side 154 along the wall 132. The left chute side 160 and the right chute side 162 are positioned as opposite side portions of the chute 102 respectively corresponding with a left side 164 of the mandoline 100 and a right side 170 of the mandoline 100 when the chute 102 is inserted in the aperture 112.

The chute 102 includes a top ridge 172, a bottom ridge 174, a left rib 180, and a right rib 182 disposed along the outer surface 134 of the chute 102. The top ridge 172 extends outward from the top chute side 152, the bottom ridge 174 extends outward from the bottom chute side 154, the left rib 180 extends outward from the left chute side 160, and the right rib 182 extends outward from the right chute side 162. The bottom ridge 174 is configured for engaging the housing 104 at a bottom edge 184 of the aperture 112, securing the chute 102 inserted in the aperture 112.

In this regard, the bottom ridge 174 extends downward from the outer surface 134 and interlocks with the bottom edge 184 from behind the aperture 112 when the chute 102 is inserted in the aperture 112. As such, the bottom ridge 174 obstructs removal of the chute 102 from the aperture 112 at the bottom chute side 154 when the chute 102 is inserted in the aperture 112. The top ridge 172, the left rib 180, and the right rib 182 are each configured to engage additional elements of the mandoline 100 to be described in more detail below.

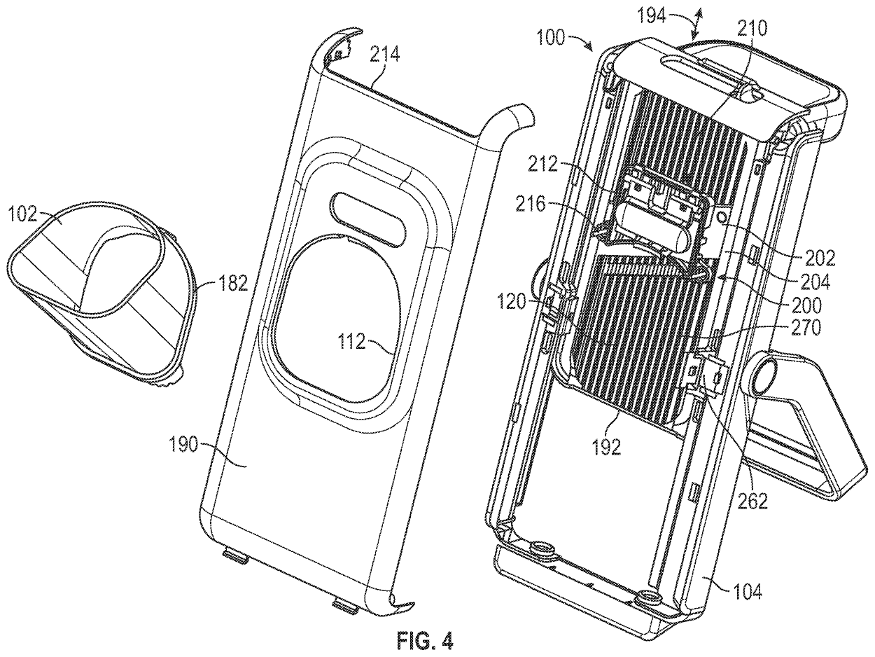

FIG. 4 depicts an exploded view of the mandoline 100 with a main housing cover 190 and the chute 102 spaced from the housing 104. As shown in FIG. 4, the mandoline 100 includes a sled 192 disposed in the housing 104. The sled 192 is connected with the housing 104 and slidable with respect to the housing 104 in a sliding direction, which is depicted with a double headed arrow 194, between a first (upper per the orientation shown in FIG. 1) position and a second (lower per the orientation shown in FIG. 1) position.

A cartridge 200 disposed in the housing 104 is connected with the sled 192 such that the sled 192 and the cartridge 200 move together with respect to the housing 104. The cartridge 200 includes the platform 120 and a blade 202 connected with a cartridge shell 204 that forms a housing of the cartridge 200. The platform 120 and the blade 202 are configured to position and then slice a food item disposed in the chute 102 when the cartridge 200 moves along with the sled 192 from the first position toward the second position with respect to the housing 104.

The housing 104 includes a catch mechanism 210 connected with the housing 104 and configured to selectively lock the chute 102 with the housing 104. The catch mechanism 210 includes a base 212 fixed with an interior side 214 of the main housing cover 190 via fasteners 216, and spaced from the platform 120 and the blade 202 in the housing 104.

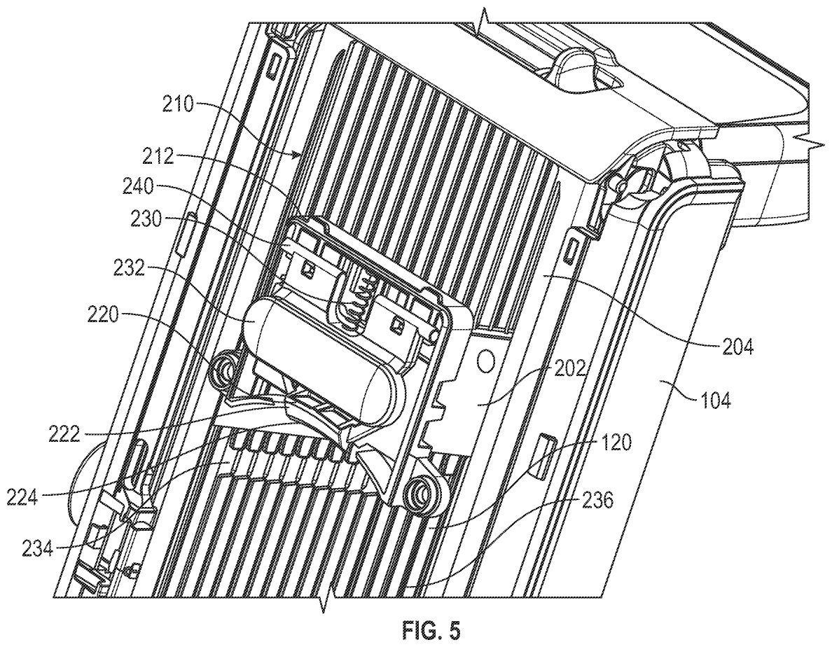

FIG. 5 depicts an enlarged view of the catch mechanism 210 from FIG. 4. As shown in FIG. 5, the catch mechanism 210 includes a protrusion 220 supported on the base 212. The protrusion 220 forms an inclined surface 222 and a step 224 extended from the base 212, and configured to engage the top ridge 172 of the chute 102 when the chute 102 is inserted in the aperture 112.

The catch mechanism 210 also includes a catch spring 230 supported on the base 212 and operatively connected with the protrusion 220. As shown in FIG. 3, the catch spring 230 biases the protrusion 220 into the aperture 112, toward the chute 102 when the chute 102 is inserted in the aperture 112. With this construction, the catch spring 230 drives the protrusion 220 in contact against the chute 102 when the chute 102 is inserted in the aperture 112, and locks the chute 102 in the aperture 112 with the protrusion 220. More specifically, inserting the chute 102 into the aperture 112 causes the top ridge 172 to contact and slide against the inclined surface 222, driving the protrusion 220 against the bias of the catch spring 230 until the top ridge 172 slides past the inclined surface 222, where catch spring 230 biases the step 224 against the chute 102. In this configuration, the step 224 obstructs movement of the top ridge 172 backward, opposite the direction of insertion, locking the chute 102 connected with the housing 104.

With reference to FIG. 5, the catch mechanism 210 also includes a button 232 configured to retract the protrusion 220 from the chute 102, unlocking the chute 102 from the housing 104. The platform 120 includes a top surface 234 that is planar, and has a plurality of ribs 236 configured to support a food item in the chute 102 to be sliced by the blade 202. The plurality of ribs 236 are oriented along the sliding direction 194, and configured support a food item in the chute 102 with a reduced contact surface area as compared to a flat surface. With this construction, a food item supported on the platform 120 more readily slides along the platform 120 in the sliding direction 194 for being sliced by the blade 202.

The button 232 is configured for being pressed in a direction normal to the top surface 234 to disengage the protrusion 220 from the chute 102, unlocking the chute 102 from the housing 104. The button 232 is supported on the base 212 via an axle 240. As such, the button 232 is configured to pivot toward the platform 120 about the axle 240 relative to the base 212 when the button 232 is pressed by a user.

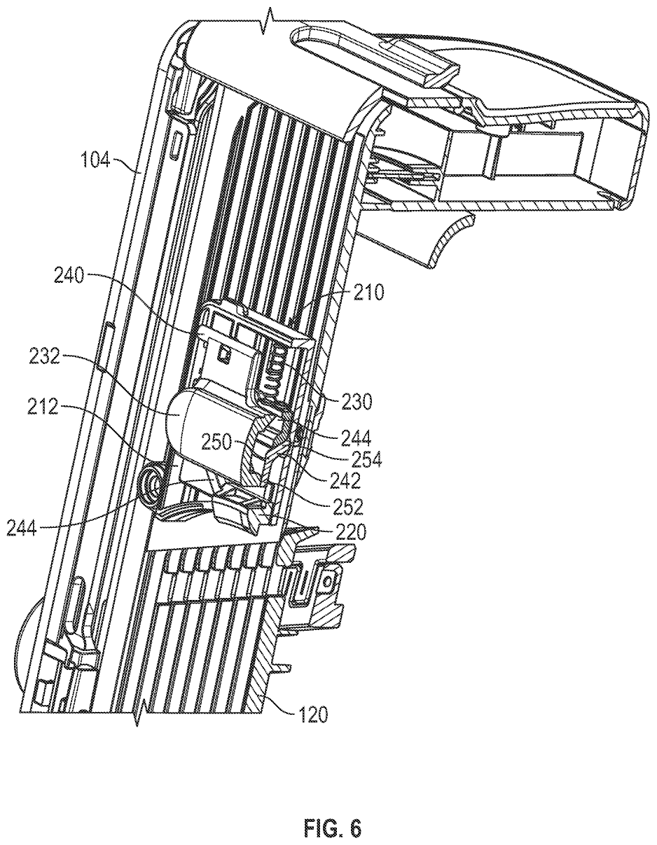

FIG. 6 depicts a cross-sectional view of the catch mechanism 210, including the protrusion 220 and the button 232. As depicted in FIG. 6, the button 232 is operably connected with the protrusion 220 through a catch lever 242 and a slide link 244.

The catch lever 242 is pivotally fixed with the base 212 via a lever hinge portion 250, at a location along the catch lever 242 between a first lever end portion 252 and a second lever end portion 254. The first lever end portion 252 and the second lever end portion 254 are configured to pivot about the lever hinge portion 250 with respect to the base 212 between a first lever position and a second lever position. The slide link 244 is configured to slide along the base 212 with the protrusion 220 to lock and unlock the chute 102 with respect to the housing 104.

The button 232 is disposed on the first lever end portion 252 such that pressing the button 232 toward the platform 120 pivots the first lever end portion 252 and the second lever end portion 254 from the first lever position toward the second lever position. The protrusion 220 is operatively connected to the catch spring 230 through the slide link 244, where the catch spring 230 biases the slide link 244 and the protrusion 220 toward the chute 102 with respect to the base 212 when the chute 102 is inserted in the aperture 112.

The slide link 244 is disposed on and configured to slide against the second lever end portion 254 such that rotating the second lever end portion 254 from the first lever position toward the second lever position drives the slide link 244 and the protrusion 220 against the bias of the catch spring 230, away from the chute 102 when the chute 102 is inserted in the aperture 112. The first lever end portion 252 and the second lever end portion 254 are fixed with the lever hinge portion 250 at an angle offset such that pressing the button 232 and the first lever end portion 252 toward the platform 120 drives the second lever end portion 254 and the slide link 244 against the bias of the catch spring 230.

When the button 232 is not pressed and the catch lever 242 is biased in the first lever position, the first lever end portion 252 presses the button 232 against the interior side 214 of the main housing cover 190. With this construction, the catch mechanism 210 is biased toward a locked configuration with the chute 102, where the button 232 raised against the housing 104 for being pressed by a user, unlocking the chute 102 from the catch mechanism 210. In this manner, the button 232 is operably connected with the protrusion 220 to drive the protrusion 220 away from the chute 102 when a user presses the button 232, unlocking the chute 102 for removal from the aperture 112, making the chute 102 is connectable and lockable with the housing 104.

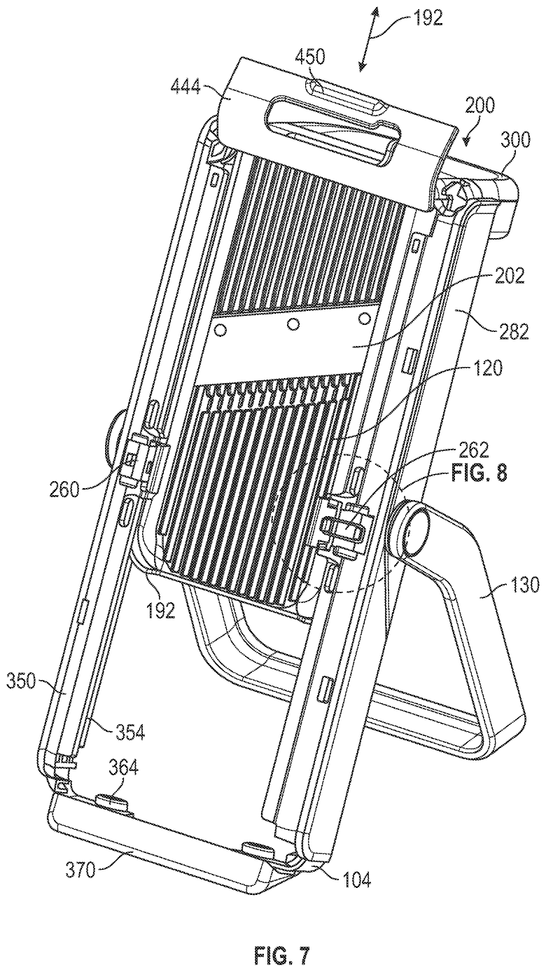

As shown in FIG. 7, the mandoline 100 includes a left sled lock 260 and a right sled lock 262 connected with the housing 104 at opposite sides of the sled 192 and the aperture 112 corresponding with the left side 164 and the right side 170 of the mandoline 100. Each of the left sled lock 260 and the right sled lock 262 are operable between a locked position in which the sled 192 is inhibited from sliding with respect to the housing 104, and an unlocked position in which the sled 192 is movable with respect to the housing 104.

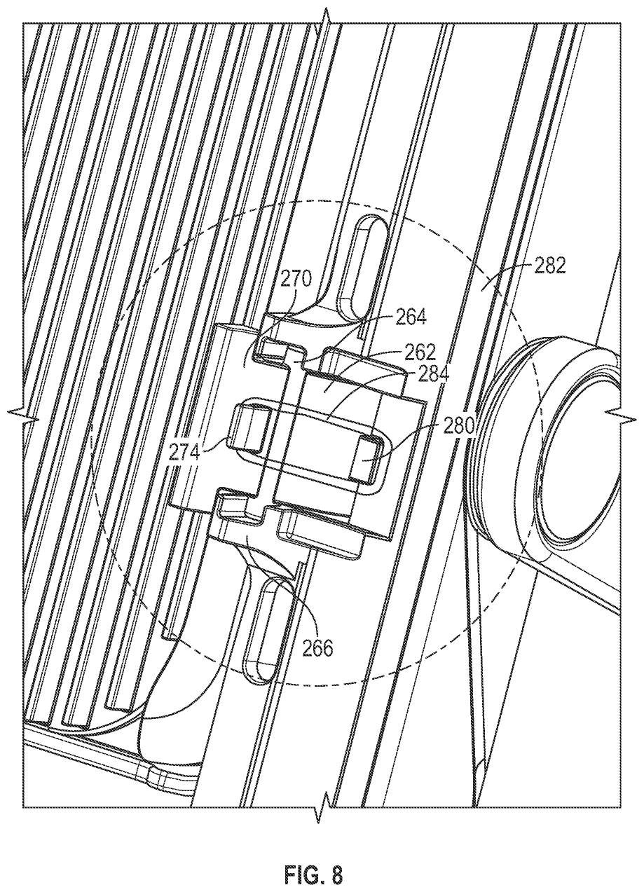

FIG. 8 depicts an enlarged view of the right sled lock 262 connected with the housing 104 as depicted in FIG. 7. As shown in FIG. 8, the right sled lock 262 is fixed with the housing 104 through a pair of pivot axles 264 inserted in respective axle mounts 266 on the housing 104. The pair of pivot axles 264 restrict the right sled lock 262 to a pivoting relationship with respect to the housing 104, where the right sled lock 262 is configured to pivot relative to the housing 104 between the locked position and the unlocked position.

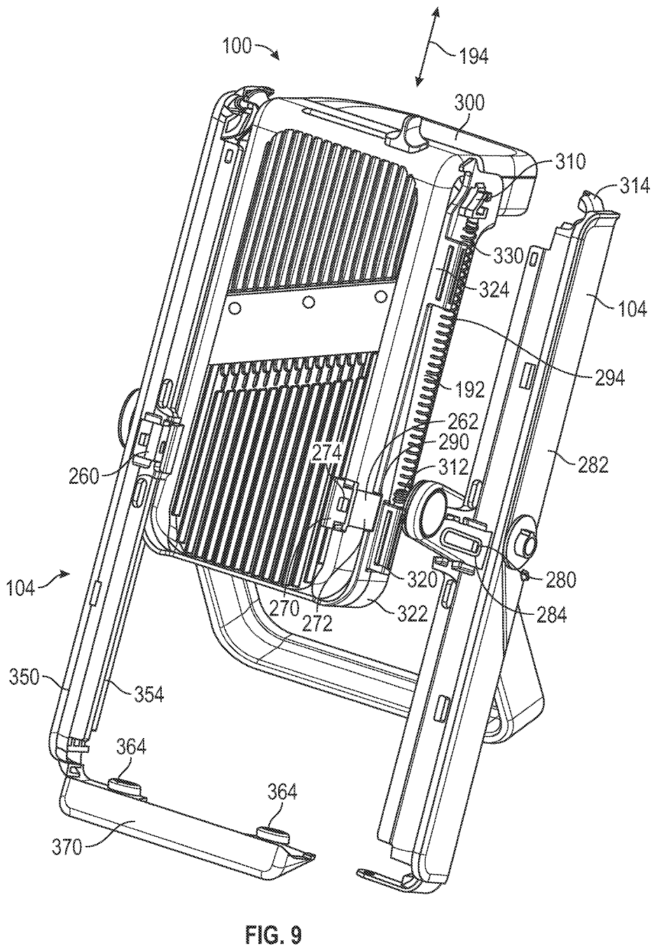

The right sled lock 262 includes a toggle end 270 and a locking end 272 (see FIG. 9) which extend from the pair of pivot axles 264 in opposite directions. With this construction, the pair of pivot axles 264 is interposed between the toggle end 270 and the locking end 272 (see FIG. 9) along the right sled lock 262. As such, the toggle end 270 and the locking end 272 are configured to travel in opposite directions when pivoting about the pair of pivot axles 264.

The toggle end 270 is configured for actuating the right sled lock 262 between the locked position and the unlocked position. The right sled lock 262 includes a sled hook 274 integrally formed with and extended from the toggle end 270.

As shown in FIG. 8, a catch 280 extends from and is fixed with a right side housing 282 included in the housing 104. An elastic band 284 extends around the sled hook 274 and the catch 280. The elastic band 284 is a tension spring that biases the right sled lock 262 toward the locked position by pulling the toggle end 270 at the sled hook 274 toward the housing 104, driving the locking end 272 toward the sled 192.

Referring back to FIG. 4, the right rib 182 is configured to engage the toggle end 270 when the chute 102 is inserted into the aperture 112 and locked with the catch mechanism 210. In this regard, the right rib 182 contacts the toggle end 270 to move the right sled lock 262 toward the unlocked position when the chute 102 is connected with the housing 104. As such, inserting the chute 102 into the aperture 112 defined by the housing 104 drives the right sled lock 262 toward the unlocked position.

FIG. 7 depicts the left sled lock 260 and the right sled lock 262 engaged with the sled 192 in the locked position. As shown in FIG. 9, the sled 192 defines a right sled notch 290 configured to catch the locking end 272 when the right sled lock 262 pivots into the locked position, obstructing movement of the sled 192 in the sliding direction 194 relative to the housing 104.

The right sled notch 290 is located along the sled 192 in the sliding direction 194 to catch the locking end 272 in the locked position when the sled 192 is in the first position. With this construction, the right sled lock 262 is configured to interlock with the sled 192 in the first position when the chute 102 is removed from the aperture 112. In this manner, a user is prevented from actuating the sled 192 in a slicing motion from the first position toward the second position without the chute 102 first installed in the housing 104, where the chute 102 covers the blade 202 from the user.

The left sled lock 260 includes similar features and functions in a similar manner as the right sled lock 262 with respect to the chute 102, the housing 104, and the sled 192. In view of this, further description of the left sled lock 260 is omitted for the sake of brevity.

As shown in FIG. 9, the mandoline 100 includes a right extension spring 294 configured to bias the sled 192 toward the first position with respect to the housing 104. A similar left extension spring (not visible) is provided on an opposite side of the sled 192. As such, the sled 192 is biased toward the first position where the sled 192 is locked from actuation in the slicing motion with respect to the housing 104 without the chute 102 first installed in the housing 104.

The cartridge 200 includes a handle 300 extended outward from the housing 104 when the cartridge 200 is received in the housing 104 as shown in FIG. 1. The handle 300 is configured for being driven by a user for actuating the sled 192 and the cartridge 200 in a slicing motion along the sliding direction 194 from the second position toward the first position.

The right extension spring 294 is connected to a right housing seat 310 fixed with the housing 104 and connected to a right sled seat 312 fixed with the sled 192. The left extension spring (not visible but similar to the right extension spring 294) is connected to a left housing seat (not visible but similar to the right housing seat 310) fixed with the housing 104 and connected to a left sled seat (not visible but similar to the right sled seat 312) fixed with the sled 192. In this manner, the left extension spring and the right extension spring 294 connect the housing 104 with the sled 192 to bias the sled 192 toward the first position.

As shown in FIG. 9, the right housing seat 310 is fixed with a top end portion 314 of the right side housing 282, upward from the right sled seat 312 in the sliding direction 194 for pulling the sled 192 in the sliding direction 194 from the second position toward the first position when the force on the handle 300 is released by the user. The right sled seat 312 is disposed on a lower right runner 320 located on a lower end portion 322 of the sled 192, below the right housing seat 310 in the sliding direction 194. The sled 192 also includes an upper right runner 324 located on an upper end portion 330 of the sled 192, above the lower right runner 320 in the sliding direction 194.

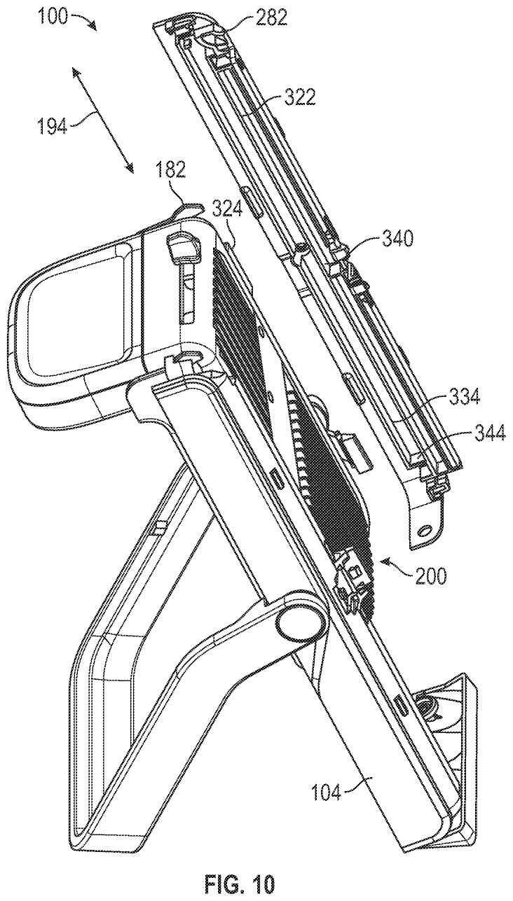

The lower right runner 320 and the upper right runner 324 are integrally formed from the sled 192 and extend outward from the sled 192 in a lateral direction perpendicular to the sliding direction 194. The upper right runner 324 and the lower right runner 320 are slidably disposed in a first right rail slot 332 and a second right rail slot 334 provided in the right side housing 282 as depicted in FIG. 10.

As shown in FIG. 10, the first right rail slot 332 and the second right rail slot 334 are formed from the right side housing 282, and defined in the right side housing 282 along the sliding direction 194. The upper right runner 324 and the lower right runner 320 are configured to slide in the first right rail slot 332 and the second right rail slot 334 with the sled 192 between the first position and the second position.

More specifically, the upper right runner 324 is configured to slide in the first right rail slot 332 between a position at a lower end portion 340 of the first right rail slot 332 corresponding with the first position of the sled 192, and a position at an upper end portion 342 of the first right rail slot 332 corresponding with the second position of the sled 192. The lower right runner 320 is configured to slide in the second right rail slot 334 between a position at a lower end portion 344 of the second right rail slot 334 corresponding with the first position of the sled 192, and a position along the second right rail slot 334 corresponding with the second position of the sled 192.

In this manner, the lower right runner 320 and the upper right runner 324 are configured to support the sled 192 in the housing 104 at the right side housing 282, and slide in the sliding direction 194 between the first position and the second position with respect to the housing 104. Referring back to FIG. 7, the housing 104 includes a left side housing 350 which forms a first left rail (not visible, but similar to the first right rail slot 332) and a second left rail 354. The first left rail and the second left rail 354 are configured to support a lower left runner (not visible, but similar to the lower right runner 320) and an upper left runner (not visible, but similar to the upper right runner 324) of the sled 192 which are not visible.

The left extension spring, the left housing seat, the left sled seat, the lower left runner, the upper left runner, and the left side housing 350 include similar features and function in a similar manner as the right extension spring 294, the right housing seat 310, the right sled seat 312, the lower right runner 320, the upper right runner 324, and the right side housing 282. In view of this further description of the left extension spring, the left housing seat, the left sled seat, the lower left runner, the upper left runner, and the left side housing 350 is omitted for the sake of brevity.

With reference to FIG. 7, the sled 192 is configured to slide along the right side housing 282 and the left side housing 350 between the first position and the second position, where the sled 192 can contact stops 364 disposed on the housing 104 when in the second position. The stops 364 are disposed on a lower housing 370 included in the housing 104. The right side housing 282, the left side housing 350, and the lower housing 370 form a frame configured to support the main housing cover 190.

As the sled 192 moves toward the second position at the lower housing 370, the left extension spring 292 and the right extension spring 294 extend. When force on the handle 300 is removed, the left extension spring 292 and the right extension spring 294 bias the sled 192 back toward the first position.

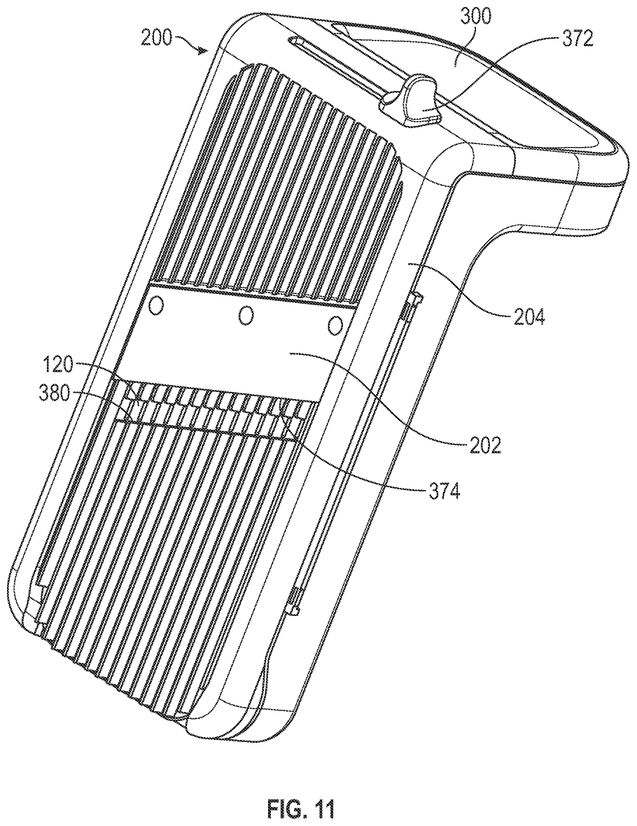

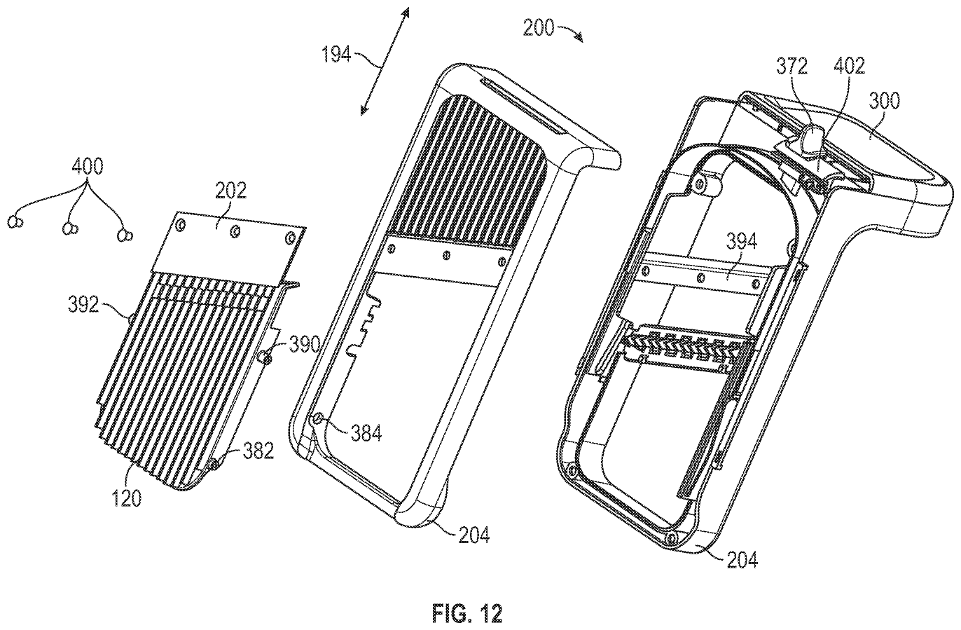

FIG. 11 depicts the cartridge 200 includes a blade adjustment mechanism operably connected with at least one of the blade 202 and the platform 120 via a control lever 372 to adjust an offset between a cutting edge 374 of the blade 202 with respect to a leading edge 380 of the platform 120. The blade adjustment mechanism is actuated between a first operating position and a second operating position, and the blade adjustment mechanism obstructs removal of the cartridge 200 from the housing 104 when the blade adjustment mechanism is in the first operating position. As shown in FIG. 11, the cartridge 200 includes the control lever 372 as an exemplary component of blade adjustment mechanism operably connected with the platform 120 to adjust the offset between the cutting edge 374 of the blade 202 with respect to the leading edge 380 of the platform 120. As shown in FIG. 12, the platform 120 is connected with the cartridge shell 204 through a lower right guide pin 382 and a lower left guide pin (not shown). The lower right guide pin 382 and the lower left guide pin are inserted in a lower right hole (not shown) and a lower left hole 384 defined in the cartridge shell 204, where the lower right guide pin 382 and the lower left guide pin are configured to pivot with respect to the cartridge shell 204.

The platform 120 also includes an upper right guide pin 390 and an upper left guide pin 392 extended from the platform 120 at a location offset from the lower right guide pin 382 and the lower left guide pin in the sliding direction 194. The upper right guide pin 390 and the upper left guide pin 392 are configured to move normal to the sliding direction 194 relative to the cartridge shell 204 such that the platform 120 pivots about the lower right guide pin 382 and the lower left guide pin with respect to the cartridge shell 204. The blade 202 is fixed with a crossbeam 394 via fasteners 400. In this manner, the upper right guide pin 390 and the upper left guide pin 392 are configured to raise and lower the leading edge 380 of the platform 120 with respect to the cutting edge 374 of the blade 202.

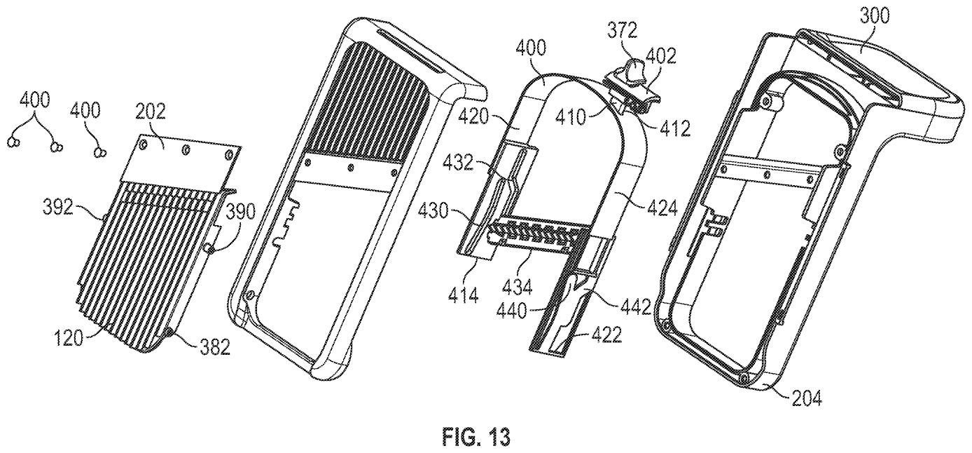

The control lever 372 is fixed with a slider 402 supported on the cartridge shell 204. The control lever 372 and the slider 402 are configured to slide along the cartridge shell 204 between a first location that is the first operating position, and a second location that is the second operating position, as actuated by a user. As shown in FIG. 13, the cartridge 200 includes a band 404 disposed in the cartridge shell 204. An extension 410 extends from the slider 402 and is received in a band opening 412 provided in the band 404. The band 404 is configured for being driven by, and sliding with the control lever 372.

The cartridge 200 includes a left lift 414 fixed with a left end portion 420 of the band 404, and a right lift 422 fixed with a right end portion 424 of the band 404. The left lift 414 and the right lift 422 are configured for sliding with the left end portion 420 and the right end portion 424 of the band 404 when the band 404 is driven by the control lever 372.

The left lift 414 includes a first left guide track 430 that supports the upper left guide pin 392, and a second left guide track 432 that supports a julienne blade assembly 434 in the cartridge 200. The right lift 422 includes a first right guide track 440 that supports the upper right guide pin 390, and a second right guide track 442 that supports the julienne blade assembly 434. The platform 120 and the julienne blade assembly 434 are configured for being raised and lowered by sliding along the first left guide track 430, the second left guide track 432, the first right guide track 440, and the second right guide track 442 in a similar manner described in U.S. Pat. No. 8,919,234 (incorporated by reference herein) when the control lever 372 is actuated between the first location and the second location.

While, in the depicted embodiment, the control lever 372 is operably connected with the platform 120 through the left lift 414 and the right lift 422 to adjust the offset between the cutting edge 374 of the blade 202 with respect to the leading edge 380 of the platform 120, the control lever 372 may alternatively be operatively connected to the blade 202 through similar lift mechanisms to adjust the offset between the cutting edge 374 and the leading edge 380 without departing from the scope of the present disclosure.

With reference to FIG. 7, the housing 104 is configured to cooperatively retain the cartridge 200 in the sled 192 with a cover 444. The cartridge 200, including the platform 120 and the blade 202, is removable from the sled 192 and the mandoline 100 as a whole by the handle 300 when unobstructed by the housing 104 and the cover 444. In this manner, the cartridge 200, including the platform 120 and the blade 202, is connectable with the sled 192, and when connected the sled 192 and the cartridge 200 move together with respect to the housing 104. With this construction, the cartridge 200 may be cleaned or refurbished separately from the remaining portions of the mandoline 100, and replaced without discarding the remaining portions of the mandoline 100.

The cover 444 is connected with the housing 104 and operable between a closed position (see FIG. 1) in which the cover 444 covers at least a portion of the sled 192 and the blade 202, and an open position (see FIG. 7) in which the cartridge 200 is removable from the housing 104. In the closed position, the cover 444 obstructs removal of the cartridge 200 from the sled 192 in the housing 104. In the open position, the cartridge 200 is unobstructed by the cover 444 and removable from the housing 104 by the handle 300.

The cover 444 is configured to pivot between the closed position and the open position relative to the housing 104. The cover 444 includes a lip 450 raised outward from the housing 104 for being pulled by a user to move the cover 444 from the closed position toward the open position.

As shown in FIG. 2, the control lever 372 extends from the sled 192 through a cover opening 452 defined in the cover 444 such that a user may actuate the control lever 372 between the first location and the second location with the cover 444 in the closed position. The control lever 372 cooperates with the cover 444 such that when the cover 444 is in the closed position, the control lever 372 inhibits movement of the cover 444 from the closed position toward the open position when the control lever 372 is in the first location.

The cover opening 452 is shaped with a narrow portion 454 and a wide portion 460 along a range of motion of the control lever 372 between the first location and the second location. When the control lever 372 is in the first location, i.e., positioned nearest a first end 456 of the cover opening 452, the narrow portion 454 of the cover opening 452 extends along the control lever 372 such that the control lever 372 obstructs movement of the cover 444 from the closed position toward the open position. When the control lever 372 is in the second location, which is shown in FIG. 2, the wide portion 460 of the cover opening 452 is spaced from the control lever 372 such that the cover 444 is not obstructed by the control lever 372 from movement between the closed position and the open position. With this construction, the cover 444 is not moveable from the closed position to the open position unless the control lever 372 is in the second location.

As such, the cartridge 200 is not removable from the housing 104 until the control lever 372 is in the second location. In this manner, the control lever 372 obstructs removal of the cartridge 200 from the housing 104 when the control lever 372 is in the first location.

While, as depicted, the mandoline 100 includes the cover 444 configured to obstruct removal of the cartridge 200 from the sled 192 in the housing 104, in an alternative embodiment of the mandoline 100 the cover 444 may not be provided. In such an embodiment, the housing 104 is configured to support the cartridge 200 in the sled 192 between the first position and the second position.

In the depicted embodiment, the second location of the control lever 372 is a single position in the range of motion of the control lever 372 on the slider 402, and corresponds with no or minimal offset between the cutting edge 374 of the blade 202 and the leading edge 380 of the platform 120. Intermediate locations, which is every other position in the range of motion of the control lever 372 on the slider 402 between the first location and the second location correspond with a nonzero offset between the cutting edge 374 and the leading edge 380 and/or exposure of julienne blades. The offset between the cutting edge 374 and the leading edge 380 defines a slicing thickness of the mandoline 100 with respect to a food item disposed in the chute 102. With this construction, the cartridge 200 is not removable from the housing 104 unless the offset between the cutting edge 374 and the leading edge 380, that is the slicing thickness of the mandoline 100, is set to zero with the control lever 372.

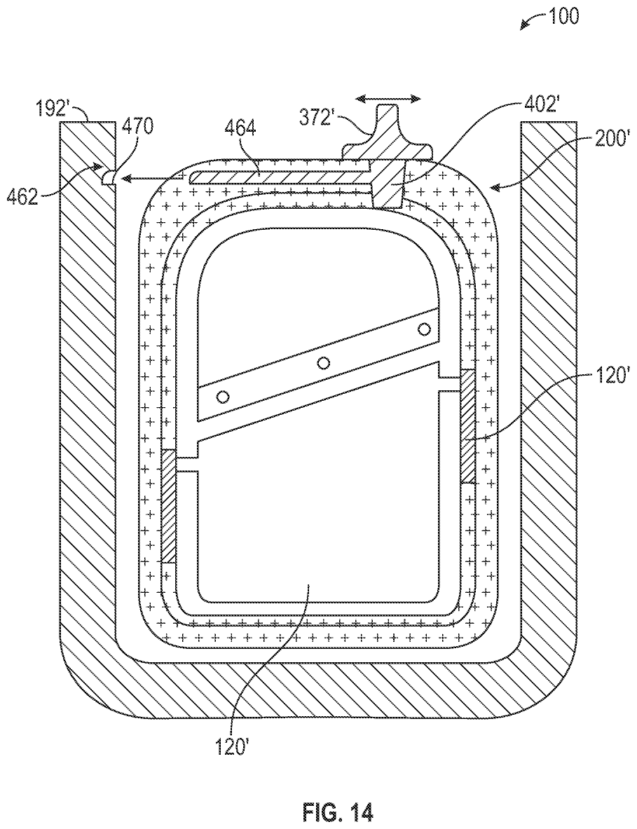

FIG. 14 illustrates an alternative embodiment of the mandoline 100 of FIGS. 1-13. In the embodiment of FIG. 14, like elements with the mandoline 100 of FIGS. 1-13 are denoted with the same reference numerals but followed by a primed suffix (′). FIG. 14 illustrates an embodiment of the mandoline 100 including another example of the blade adjustment mechanism where the slider 402′ and the sled 192′ form a slide latch mechanism 462 configured to selectively lock the cartridge 200′ with the sled 192′.

In this regard, the slider 402′ includes a latch pin 464 extended from the cartridge 200′ toward the sled 192′, such that the latch pin 464 moves with the slider 402′ when the control lever 372′ is actuated to adjust the slicing thickness of the mandoline 100. The sled 192′ defines a recess 470 configured to catch the latch pin 464 when the control lever 372′ is positioned at a location corresponding with a nonzero slicing thickness. With the latch pin 464 inserted in the recess 470, the slide latch mechanism 462 obstructs movement of the cartridge 200′ from the sled 192′. In this manner, the slide latch mechanism 462 is configured to lock the cartridge 200′ with the sled 192′ when the mandoline 100 is set to a nonzero slicing thickness.

When the control lever 372′ is positioned at a location corresponding with a zero slicing thickness, the latch pin 464 is removed from the recess 470 disengages the sled 192′. With the latch pin 464 removed from the recess 470, the cartridge 200′ is unobstructed from movement from the sled 192′. In this manner, the slide latch mechanism 462 is configured to unlock the cartridge 200′ with the sled 192′ when the mandoline 100 is set to a zero slicing thickness.

In an embodiment, the latch pin 464 is configured to click with the housing 104 at the recess 470 when the latch pin 464 is inserted into the recess 470, and when the latch pin 464 is removed from the recess 470. In this manner, the slide latch mechanism 462 is configured to produce tactile feedback to a user operating the control lever 372′ to lock and unlock the cartridge 200′ from the sled 192′.

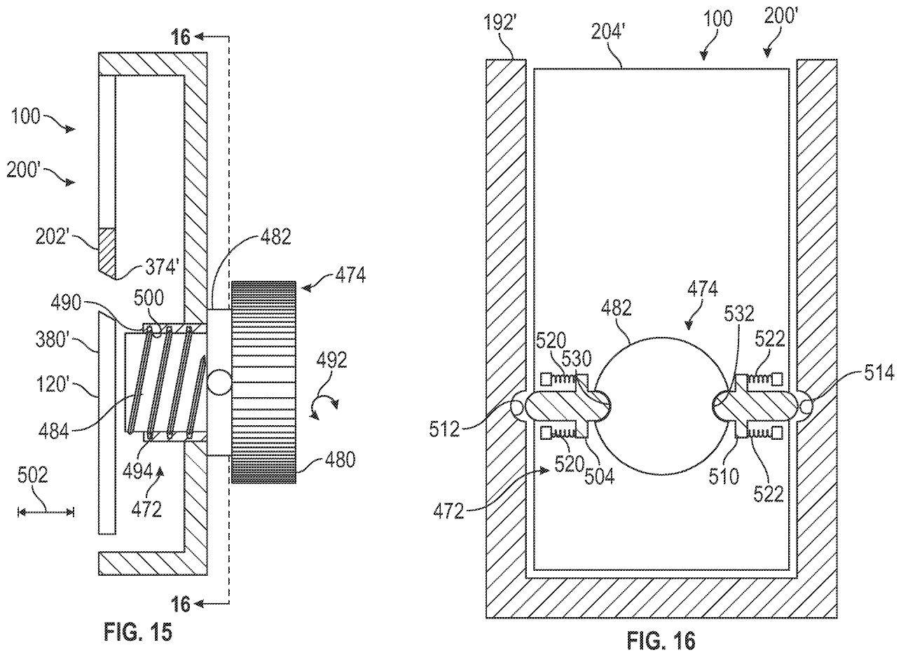

FIGS. 15 and 16 illustrate an alternative embodiment of the mandoline 100 of FIGS. 1-13 . In the embodiment of FIGS. 15 and 16, like elements with the mandoline 100 of FIGS. 1-13 are denoted with the same reference numerals but followed by a primed suffix (′). FIGS. 15 and 16 illustrate an embodiment of the mandoline 100 including a cam latch mechanism 472 as another example of the blade adjustment mechanism. In this regard, the cam latch mechanism 472 is configured to adjust the offset between the cutting edge 374′ of the blade 202′ and the leading edge 380′ of the platform 120′, and selectively lock the cartridge 200′ with the sled 192′.

As shown in FIG. 15, the cam latch mechanism 472 includes a leadscrew 474 formed from a knob 480, a cam 482, and a threaded shank 484. The knob 480 is connected to the cartridge 200′ through the cam 482 at the threaded shank 484. The threaded shank 484 is threaded into a cartridge hole 490 defined in the cartridge shell 204′, from which the threaded shank 484 extends through the cartridge 200′ to contact and support the blade 202′.

The knob 480 is configured for being gripped by a user for turning the knob 480 with respect to the cartridge 200′ in a rotating direction, which is depicted with a double headed arrow 492. The knob 480, the cam 482, and the threaded shank 484 are fixed with each other such that turning the knob 480 relative to the cartridge shell 204′ also turns the cam 482 and the threaded shank 484 relative to the cartridge shell 204′.

The leadscrew 474 includes threading 494 on the threaded shank 484 and the cartridge shell 204′ includes cartridge threading 500 disposed around an inner periphery of the cartridge hole 490. The threading 494 is complementary with the cartridge threading 500 such that turning the knob 480 and rotating the threaded shank 484 in the rotating direction 492 relative to the cartridge shell 204′ drives the leadscrew 474 with respect to the cartridge 200′ in a translating direction, which is depicted with a double headed arrow 502.

The offset between the cutting edge 374′ of the blade 202′ and the leading edge 380′ of the platform 120′ extends along the translating direction 502, and the blade 202′ is connected with the threaded shank 484 for being driven in the translating direction 502 with the leadscrew 474. With this construction, turning the knob 480 in the rotating direction 492 drives the blade 202′ in the translating direction 502, thereby adjusting the offset between the cutting edge 374′ of the blade 202′ and the leading edge 380′ of the platform 120′.

The cam 482 is interposed between and separates the knob 480 and the threaded shank 484 along the leadscrew 474. An outer diameter of the cam 482 is larger than an inner diameter of the cartridge hole 490 such that the cam 482 obstructs further insertion of the threaded shank 484 into the cartridge shell 204′ beyond a maximum position in the translating direction 502, which corresponds to a zero slicing thickness of the mandoline 100. Withdrawing the leadscrew 474 from the cartridge 200′ in the translating direction 502 moves the threaded shank 484 from the maximum position, to a position corresponding with a nonzero slicing thickness of the mandoline 100.

As shown in FIG. 16, the cam latch mechanism 472 includes a first lock pin 504 and a second lock pin 510 configured for selectively locking the cam 482 with the sled 192′. In this regard, the first lock pin 504 and the second lock pin 510 are mounted on the cartridge 200′, the sled 192′ defines a first sled catch 512 configured for receiving the first lock pin 504, and the sled 192′ defines a second sled catch 514 configured for receiving the second lock pin 510.

When the first lock pin 504 is received in the first sled catch 512, the first lock pin 504 and the first sled catch 512 obstruct movement of the cartridge 200′ from the sled 192′. Similarly, when the second lock pin 510 is received in the second sled catch 514, the second lock pin 510 and the second sled catch 514 obstruct movement of the cartridge 200′ from the sled 192′. In this manner, the cam latch mechanism 472 is configured to lock the cartridge 200′ with the sled 192′ so as to preclude removal of the cartridge 200′ from the sled 192′.

The first lock pin 504 is supported on the cartridge shell 204′ via a first set of lock pin springs 520 which bias the first lock pin 504 toward the cam 482. The second lock pin 510 is supported on the cartridge shell 204′ via a second set of lock pin springs 522 which bias the second lock pin 510 toward the cam 482. As such, the first lock pin 504 and the second lock pin 510 are each biased toward the cam 482 to be in contact with a cam surface 524 that defines an outer periphery of the cam 482.

The cam surface 524 defines a first cam catch 530 and a second cam catch 532 respectively configured for receiving the first lock pin 504 and the second lock pin 510 when the threaded shank 484 is disposed in the maximum position. When the first cam catch 530 receives the first lock pin 504, the first lock pin 504 is removed from the first sled catch 512, unlocking the cartridge 200′ from the sled 192′ at the first lock pin 504. When the second cam catch 532 receives the second lock pin 510, the second lock pin 510 is removed from the second sled catch 514, unlocking the cartridge 200′ from the sled 192′ at the second lock pin 510.

With this construction, the cam latch mechanism 472 unlocks the cartridge 200′ from the sled 192′ when the threaded shank 484 is disposed in the maximum position, where the slicing thickness of the mandoline 100 is set to zero. Also, the cam latch mechanism 472 locks the cartridge 200′ with the sled 192′ when the threaded shank 484 is not disposed in the maximum position and, where the mandoline 100 is set to a nonzero slicing thickness.

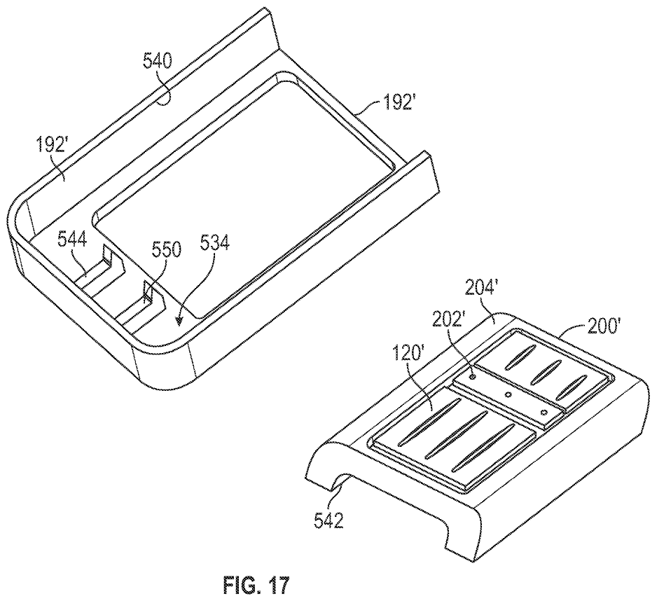

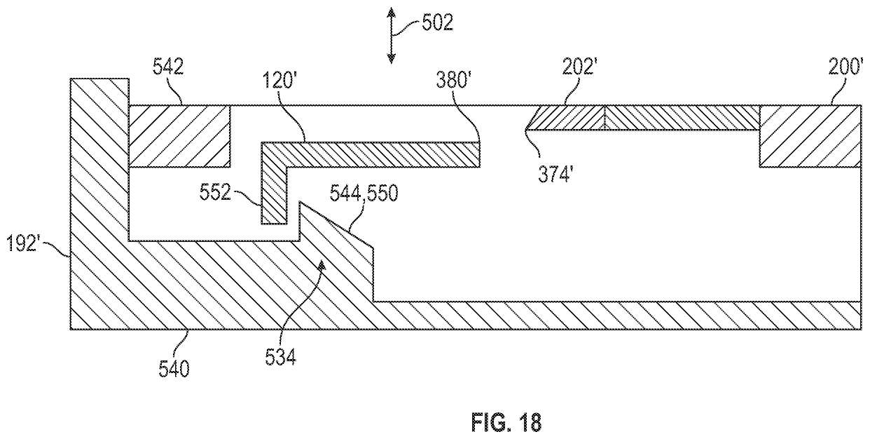

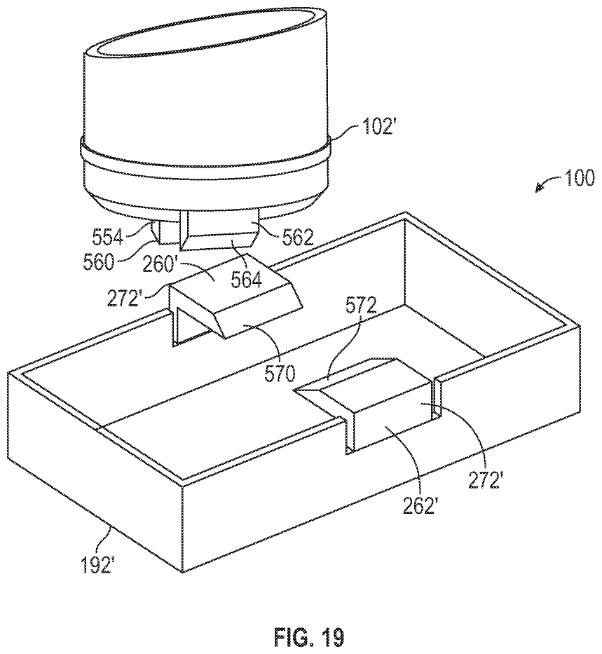

FIGS. 17 and 18 illustrate an alternative embodiment of the mandoline 100 of FIGS. 1-13 . In the embodiment of FIGS. 17 and 18, like elements with the mandoline 100 of FIGS. 1-13 are denoted with the same reference numerals but followed by a primed suffix (′). FIGS. 17 and 18 illustrate an embodiment of the mandoline 100 including a platform lock mechanism 534 configured to lock the cartridge 200′ with the sled 192′ based on a height of the platform 120′ with respect to the sled 192′.

In this regard, as shown in FIG. 17, the sled 192′ defines an open bottom portion 540 configured for receiving the cartridge shell 204′. The cartridge shell 204′ defines an open top portion 542 configured for engaging the open bottom portion 540 of the sled 192′, connecting the cartridge shell 204′ in a sliding relationship with the sled 192′ as shown in FIG. 18. The platform lock mechanism 534 includes a first platform lock 544 and a second platform lock 550 which extend from the open bottom portion 540.

With reference to FIG. 18, the first platform lock 544 and the second platform lock 550 are projections integrally formed with the sled 192′, and extend from the sled 192′ toward the platform 120′ when the sled 192′ is assembled with the cartridge 200′. The platform lock mechanism 534 includes a platform hook 552 that is a projection which extends from the platform 120′ toward the first platform lock 544 and the second platform lock 550. The platform hook 552 is configured to selectively engage the first platform lock 544 and the second platform lock 550 to lock the cartridge 200′ with the sled 192′.

The platform hook 552 can be integrally formed from the platform 120′ and moves with the platform 120′ in adjusting the offset between the cutting edge 374′ of the blade 202′ with respect to the leading edge 380′ of the platform 120′. When the platform 120′ is lowered toward the sled 192′ from a position corresponding to no or minimal offset between the cutting edge 374′ of the blade 202′ with respect to the leading edge 380′ of the platform 120′, i.e. a zero or minimum slicing thickness of the mandoline 100, the platform hook 552 catches the first platform lock 544 and the second platform lock 550, obstructing sliding motion between the sled 192′ and the cartridge 200′. In this manner, the first platform lock 544 and the second platform lock 550 are configured to engage the platform hook 552 to lock the cartridge 200′ with the sled 192′.

When the platform 120′ is disposed in the position corresponding to no or minimal offset between the cutting edge 374′ of the blade 202′ with respect to the leading edge 380′ of the platform 120′, i.e. a zero or minimum slicing thickness of the mandoline 100, the platform hook 552 is configured to slide over the first platform lock 544 and the second platform lock 550 with the cartridge shell 204′. In this manner, the cartridge 200′ is unlocked and removable from the sled 192′ by sliding the cartridge shell 204′ from the sled 192′ when the mandoline 100 is set to zero slicing thickness.

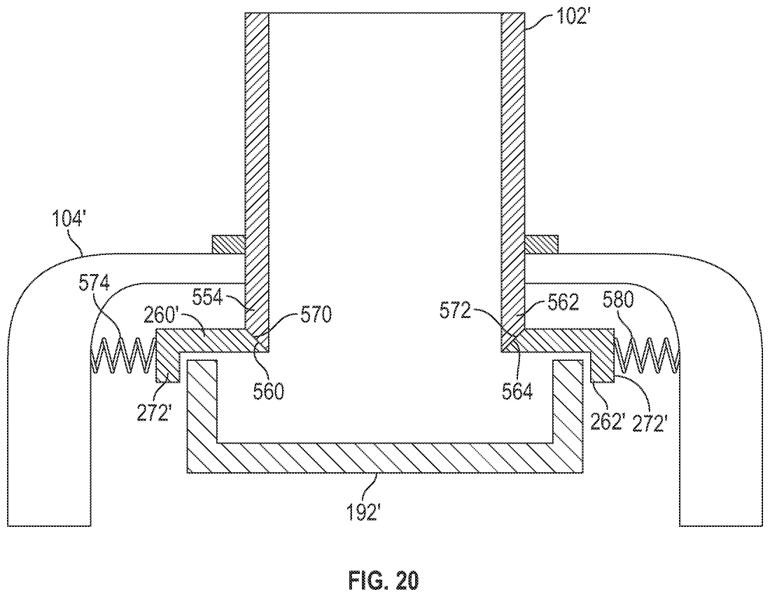

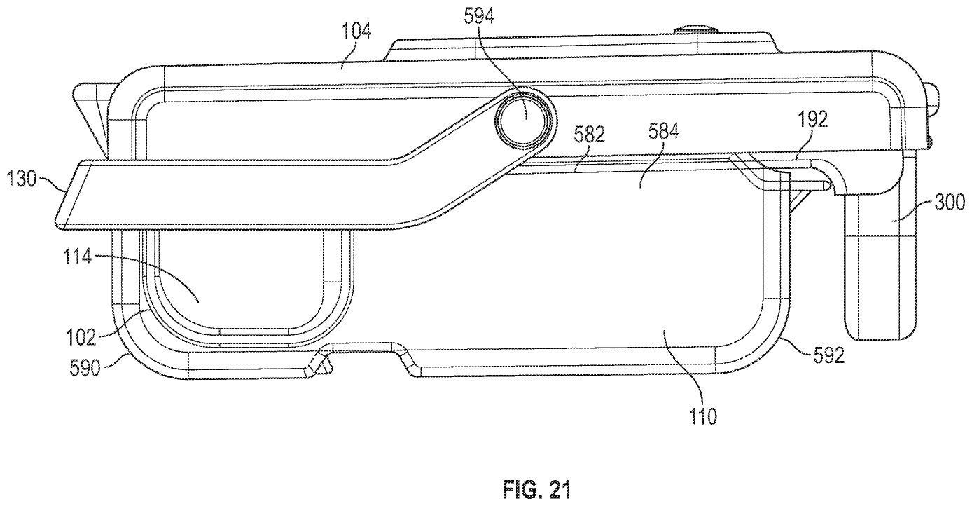

FIGS. 19 and 20 illustrate an alternative embodiment of the mandoline 100 of FIGS. 1-13 . In the embodiment of FIGS. 19 and 20, like elements with the mandoline 100 of FIGS. 1-13 are denoted with the same reference numerals but followed by a primed suffix (′). FIGS. 19 and 20 illustrate an embodiment of the mandoline 100 where the left sled lock 260′ and the right sled lock 262′ are configured to slide between the locked position and the unlocked position.

As shown between FIGS. 19 and 20, the chute 102 includes a left arm 554 which defines a left arm ramp surface 560 inclined toward the left sled lock 260′, and a right arm 562 which defines a right arm ramp surface 564 inclined toward the right sled lock 262′. The left arm 554 and the right arm 562 are configured to engage the left sled lock 260′ and the right sled lock 262′ when the chute 102 is inserted in the housing 104.

The left sled lock 260′ defines a left sled lock ramp surface 570 configured to engage the left arm ramp surface 560. The left sled lock ramp surface 570 is complementary with, and inclined away from the left arm ramp surface 560 such that the left sled lock 260′ slides away from the sled 192′ in the lateral direction, perpendicular to the sliding direction 194 and direction of inserting the chute 102 when the chute 102 is inserted in the housing 104. In this manner, the left arm 554 is configured to drive the locking end 272′ of the left sled lock 260′ away from the sled 192′, unlocking the sled 192′ from the housing 104 at the left sled lock 260′.

The right sled lock 262′ defines a right sled lock ramp surface 572 configured to engage the right arm ramp surface 564. The right sled lock ramp surface 572 mirrors the left sled lock ramp surface 570 across the sled 192′ in the lateral direction. The right sled lock ramp surface 572 is complementary with, and inclined away from the right arm ramp surface 564 such that the right sled lock 262′ slides away from the sled 192′ in the lateral direction when the chute 102 is inserted in the housing 104. In this manner, the right arm 562 is configured to drive the locking end 272′ of the right sled lock 262′ away from the sled 192′, unlocking the sled 192′ from the housing 104 at the right sled lock 262′.

With reference to FIG. 20, the left sled lock 260′ is mounted to the housing 104 on a left spring 574, and the right sled lock 262′ is mounted to the housing 104 on a right spring 580. The left spring 574 biases the locking end 272′ of the left sled lock 260′ toward the sled 192′, and biases the left sled lock ramp surface 570 into engagement with the left arm 554. The right spring 580 biases the locking end 272′ of the right sled lock 262′ toward the sled 192′, and biases the right sled lock ramp surface 572 into engagement with the right arm 562. In this manner, the left sled lock 260′ and the right sled lock 262′ are biased toward the locked position, and configured for being driven toward the unlocked position by the chute 102 inserted in the housing 104.

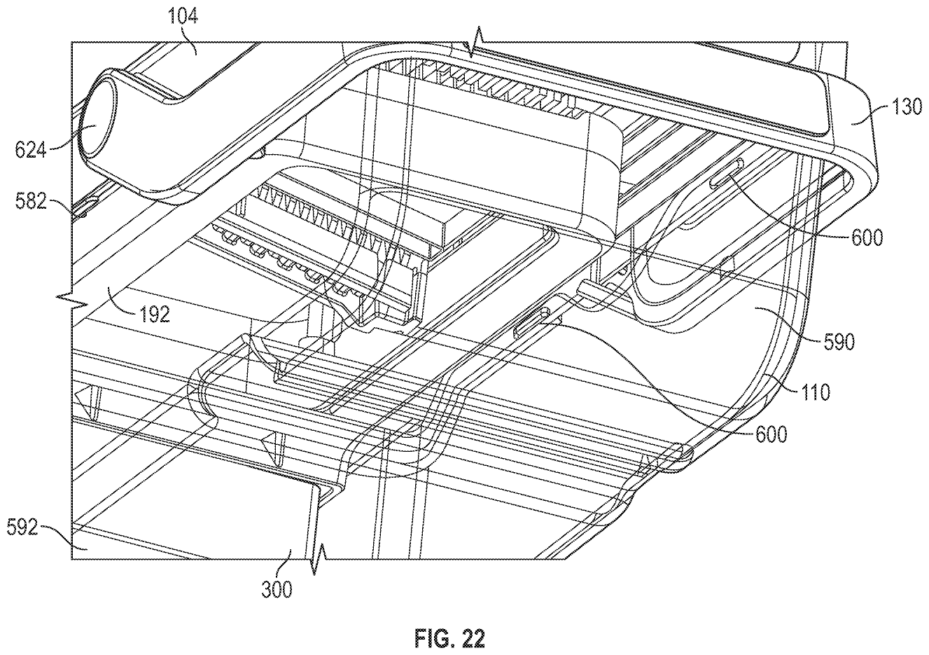

FIGS. 21-26 illustrate further details of the mandoline 100 depicted in FIGS. 1-13 . FIGS. 21 and 22 depict the chute 102, the housing 104, the container 110, the food pusher 114, and the sled 192 in a stored state. As shown in FIG. 21, the container 110 is shaped to nest with the housing 104 and the sled 192 in the stored state, where the chute 102 and the food pusher 114 are stored in the container 110.

More specifically, the housing 104 and the sled 192, assembled together, fit over a container rim 582 at a top side 584 of the container 110. The container rim 582 at a front end 590 of the container 110 fits between the housing 104 and the sled 192. The container rim 582 extends below and across the housing 104 and the sled 192 at a back end 592 of the container 110. With this construction, the back end 592 of the container 110 accommodates the handle 300 in the stored state.

In the stored state, the leg 130 is disposed in a first position around the front end 590 of the container 110. The housing 104 includes a right leg joint 594 extended from the right side housing 282, and the leg 130 is fixed in a pivoting relationship to the housing 104 via the right leg joint 594.

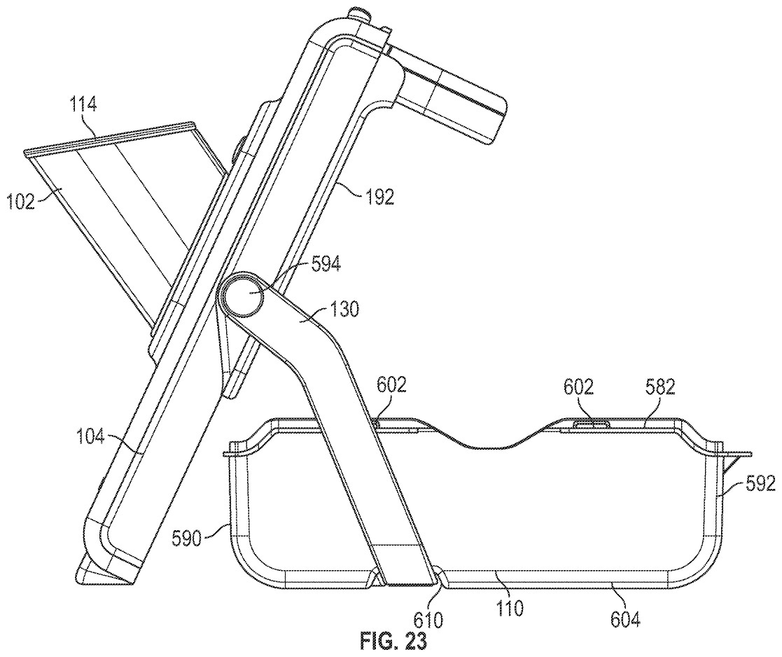

With reference to FIG. 22, the housing 104 includes side protrusions 600 complementary with rim notches 602, shown in FIG. 23, defined in the container rim 582 for holding the housing 104 and the container 110 in the stored state. The side protrusions 600 and rim notches 602 are mating snap features which releasably engage the housing 104 and the container 110 in the stored state. The side protrusions 600 and the rim notches 602 are disposed around a perimeter of the container 110 at the container rim 582, including the front end 590 and the back end 592, where the container rim 582 aligns with the housing 104.

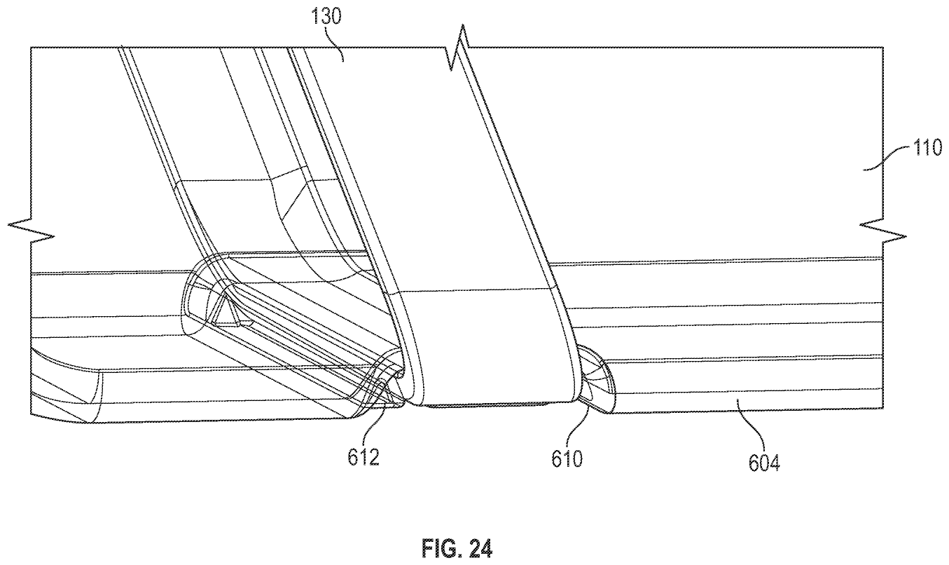

FIG. 23 depicts the chute 102, the housing 104, the container 110, the food pusher 114, and the sled 192 in an in-use state where the leg 130 engages a bottom side 604 of the container 110. The leg 130 is configured to pivot around the right leg joint 594 relative to the housing 104 between the first position corresponding to the stored state depicted in FIGS. 21 and 22, and a second position corresponding to the in-use state depicted in FIGS. 23 and 24.

With reference to FIGS. 23 and 24, the container 110 defines a groove 610 in the bottom side 604. The groove 610 is configured to releasably engage the leg 130 in the second position, holding the container 110 below the housing 104 when in the in-use state. As shown in FIG. 24, the groove 610 is defined by an angled ledge 612, and configured to receive the leg 130 in a snug fit such that the leg 130 snaps over the angled ledge 612. With this construction, the container 110 and the leg 130 are configured to provide a positive interface to a user assembling the housing 104 and the container 110 in the in-use state.

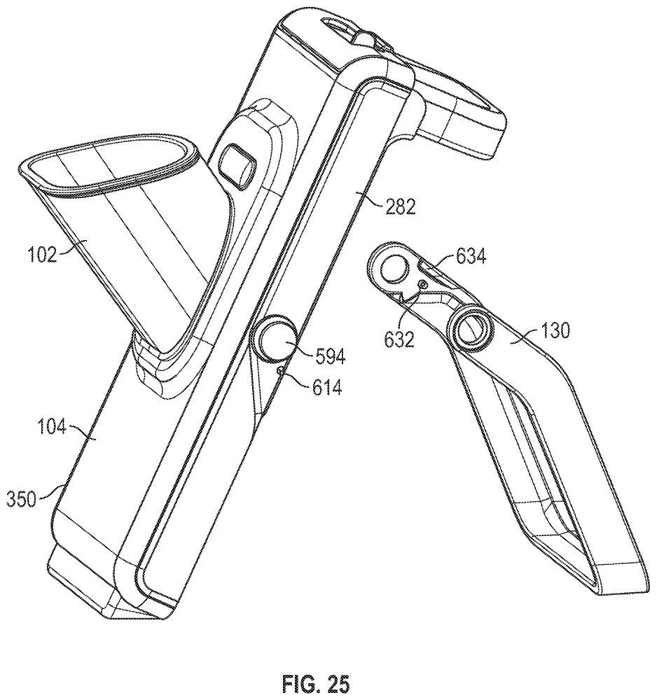

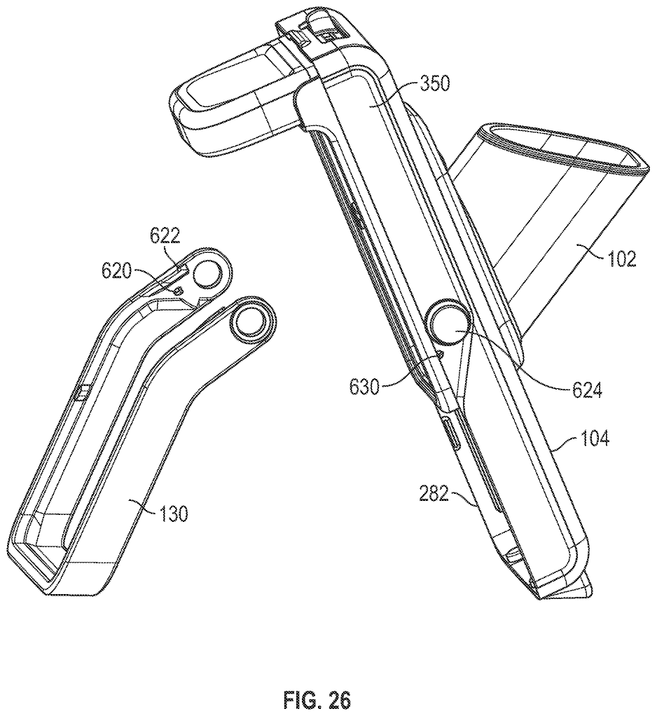

As shown between FIGS. 25 and 26, the right side housing 282 and the leg 130 cooperatively restrict movement of the leg 130 about the right leg joint 594 to a range of motion between the first position and the second position. In this regard, a right protrusion 614 extended from the right side housing 282 is configured for being received in a right leg detent 620 when the leg 130 is deployed in the second position. The right leg detent 620 is configured to releasably catch the right protrusion 614 when the leg 130 pivots from the first position to the second position. The leg 130 also includes a right leg wall 622 extended from the leg 130 toward the right side housing 282 and configured to abut the right protrusion 614 when the leg 130 is in the first position, obstructing further motion of the leg 130 from the second position beyond the first position. In this manner, the right leg wall 622 is configured to obstruct motion of the leg 130 from the second position to a location beyond the first position, retaining the leg 130 in the first position.

The housing 104 includes a left leg joint 624 and a left protrusion 630 extended from the left side housing 350′, a left leg detent 632 defined in the leg 130, and a left leg wall 634 extended from the leg 130 toward the left side housing 350. The left leg joint 624, the left protrusion 630, the left leg detent 632, and the left leg wall 634 include similar features and function in a similar manner as the right leg joint 594, the right protrusion 614, the right leg detent 620, and the right leg wall 622 to restrict movement of the leg 130 about the left leg joint 624 to a range of motion between the first position and the second position.

It will be appreciated that various of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A mandoline comprising:
a housing;
a sled connected with the housing and slidable with respect to the housing;
a blade connected with the sled such that the sled and the blade move together with respect to the housing;
a chute connectable with the housing; and
a sled lock connected with the housing and operable between a locked position in which the sled is inhibited from sliding with respect to the housing, and an unlocked position in which the sled is movable with respect to the housing, wherein the chute contacts the sled lock to move the sled lock toward the unlocked position when the chute is connected with the housing.

2. The mandoline of claim 1, wherein the sled lock includes a toggle end configured to engage the chute and actuate the sled lock toward the unlocked position when the chute is connected to the housing,
the sled lock includes a locking end extended from the toggle end and configured for engaging the sled when the sled lock is in the locked position, and
the mandoline further comprises a spring connected with the sled lock and the housing, wherein the spring biases the sled lock toward the locked position.

3. The mandoline of claim 2, wherein the sled lock is fixed to the housing through a pivot axle that restricts the sled lock to a pivoting relationship with the housing, and
the toggle end and the locking end extend from the pivot axle in opposite directions, such that the toggle end and the locking end are configured to travel in opposite directions when pivoting about the pivot axle.

4. The mandoline of claim 2, wherein the housing defines an aperture, the toggle end is disposed within the aperture, and the chute connects with the housing when inserted into the aperture, and the chute engages the toggle end when inserted into the aperture.

5. The mandoline of claim 1, wherein the housing defines an aperture,
the chute connects with the housing when inserted into the aperture,
the sled lock is a first sled lock, and the mandoline further comprises a second sled lock connected with the housing and operable between a locked position in which the sled is inhibited from sliding with respect to the housing, and an unlocked position in which the sled is movable with respect to the housing,
the chute contacts the first sled lock and the second sled lock to move the first sled lock and the second sled lock toward the unlocked position when the chute is inserted into the aperture and connected with the housing, and
the first sled lock and the second sled lock extend across opposite sides of the aperture when the first sled lock and the second sled lock are disposed in the locked position.

6. The mandoline of claim 1, wherein the housing defines an aperture,
the chute connects with the housing when inserted into the aperture, and
the chute is formed from a wall having an outer surface complementary to the aperture such that the chute is inhibited from rotating relative to the housing, around a direction in which the chute is inserted into the housing, when the chute is inserted in the aperture.

7. The mandoline of claim 6, further comprising:
a platform connectable with the sled; and
a catch mechanism connected with the housing, the catch mechanism including:
a protrusion configured to engage the chute, locking the chute connected with the housing such that the chute maintains contact with the sled lock when inserted in the aperture;
a catch spring that biases the protrusion toward engagement with the chute when the chute is inserted in the aperture, and
a button configured to disengage the protrusion from the chute, wherein pressing the button normal to the platform drives the protrusion from the chute, unlocking the chute from the housing.

8. The mandoline of claim 1, wherein the housing is configured to retain the blade in the sled with a cover, and the blade is removable from the sled when unobstructed by the housing and the cover.

9. A mandoline comprising:
a housing;
a sled connected with the housing and slidable with respect to the housing;
a cartridge including a blade and a platform connectable with the sled, when connected the sled and the cartridge move together with respect to the housing;
a blade adjustment mechanism operably connected with at least one of the blade and the platform to adjust an offset between a cutting edge of the blade with respect to a leading edge of the platform wherein the blade adjustment mechanism is actuated between a first operating position and a second operating position, and the blade adjustment mechanism obstructs removal of the cartridge from the housing when the blade adjustment mechanism is in the first operating position.

10. The mandoline of claim 9, further comprising a cover configured to cooperatively retain the cartridge in the sled with the housing, wherein the cover is operable between a closed position in which the cover obstructs the sled from being removed from the housing, and an open position in which the cartridge is removable from the housing.

11. The mandoline of claim 10, wherein the cover defines a cover opening, and the blade adjustment mechanism includes a control lever that extends from the sled through the cover opening such that the control lever is moveable between the first operating position and the second operating position with the cover in the closed position, and
when the control lever is in the first position, the blade adjustment mechanism obstructs movement of the cover from the closed position toward the open position.

12. The mandoline of claim 11, wherein the cover opening is shaped with a narrow portion and a wide portion along a range of motion of the control lever between the first operating position and the second operating position, with the narrow portion disposed at the first operating position, and the wide portion disposed at the second operating position,
when the control lever is in the first operating position, the narrow portion of the cover opening extends along the control lever such that the control lever obstructs movement of the cover from the closed position toward the open position, and
when the control lever is in the second operating position, the wide portion of the cover opening is spaced from the control lever such that the cover is not obstructed by the control lever from movement between the closed position and the open position.

13. The mandoline of claim 12, wherein the cover is configured to pivot between the closed position and the open position relative to the housing, and includes a lip raised outward from the housing for being pulled by a user to pivot the cover from the closed position toward the open position, and
the control lever obstructs the cover from pivoting from the closed position toward the open position at the narrow portion when the control lever is in the first operating position.

14. The mandoline of claim 9, wherein the second operating position of the blade adjustment mechanism corresponds with a minimal offset between a cutting edge of the blade and a leading edge of the platform.

15. A mandoline comprising:
a housing;
a platform connectable with the housing;
a blade connectable with the housing, when connected the platform and the blade move together with respect to the housing;
a chute connectable with the housing and configured to store a food item against the platform;
a ridge disposed along an outer surface of the chute;
a catch mechanism connected with the housing, the catch mechanism including:
a protrusion configured to engage the ridge, locking the chute connected with the housing;
a catch spring that biases the protrusion toward engagement with the ridge, and
a button operable to disengage the protrusion from the ridge, wherein pressing the button normal to the platform drives the protrusion from the ridge, unlocking the chute from the housing.

16. The mandoline of claim 15, further comprising a sled lock connected with the housing and operable between a locked position in which the sled is inhibited from sliding with respect to the housing, and an unlocked position in which the sled is movable with respect to the housing, wherein the chute contacts the sled lock to move the sled lock toward the unlocked position when the chute is locked with the housing by the catch mechanism.

17. The mandoline of claim 16, wherein the housing defines an aperture, the protrusion and the sled lock are disposed within the aperture, and the chute connects with the housing when inserted into the aperture, and when inserted into the aperture the chute engages the protrusion and the sled lock.

18. The mandoline of claim 15, wherein the catch mechanism includes a base fixed to an interior side of the housing,
the button, the catch spring, and the protrusion are supported on the base, and
the button extends from the base, through the housing from the interior side.

19. The mandoline of claim 18, wherein the protrusion forms an inclined surface extended from the base and configured to engage the ridge when the chute is connected with the housing.

20. The mandoline of claim 18, wherein the button is supported on the base via an axle and configured to pivot toward the platform about the axle when the button is pressed by a user.

21. The mandoline of claim 18, wherein the button is operably connected with the protrusion through a slide link configured to slide along the base with the protrusion to lock and unlock the chute with the housing, and
the catch spring biases the slide link and the protrusion toward the chute from the base when the chute is connected with the housing.

22. (canceled)

23. (canceled)

24. (canceled)

25. (canceled)

26. (canceled)
